(19) United States
(12) Patent Application Publication
(10) Pub. No.: US 2024/0060602 A1
(43) Pub. Date: Feb. 22, 2024

(54) SYSTEMS AND METHODS FOR HEAT MANAGEMENT FOR CASED WELLBORE COMPRESSED AIR STORAGE

(71) Applicant: CleanTech Geomechanics, Inc., Calgary (CA)

(72) Inventors: Roman A. Bilak, Calgary (CA); Sunghyun Park, Newmarket (CA); Maurice B. Dusseault, Calgary (CA)

(21) Appl. No.: 18/260,681

(22) PCT Filed: Jan. 7, 2022
(86) PCT No.: PCT/CA2022/050019

§ 371 Date: Jul. 7, 2023

Related U.S. Application Data
(60) Provisional application No. 63/135,253, filed on Jan. 8, 2021.

(51) Int. Cl. F17C 1/00; F24T 50/00

(52) U.S. Cl. CPC F17C 1/007; F24T 50/00; F17C 2260/046; F17C 2223/0123; F17C 2223/036

(57) ABSTRACT

Systems and methods for recovery, storing and utilizing heat energy during compressed gas energy storage are disclosed. In an example, a system for storing energy in a form of compressed gas, comprising: one or more energy storage vessels for storing compressed gas, said energy storage vessels each comprising: a wellbore provided in a subsurface; and a casing placed within the wellbore and cemented to a surrounding geological medium, the casing defining a volumetric space for storing the compressed gas; and a geothermal reservoir formed at the surrounding geological medium of the one or more energy storage vessels for underground thermal energy storage, wherein a portion of thermal energy of the compressed gas stored in the one or more storage vessels is conductively transferred to, via the one or more storage vessels, the surrounding geological medium, and stored in the surrounding geological medium.

### CROSS-REFERENCE TO RELATED APPLICATIONS

This application claims priority to U.S. provisional patent application Ser. No. 63/135,253, filed Jan. 8, 2021, which is hereby incorporated by reference in its entirety.

### FIELD

The present application relates generally to heat management for cased wellbore compressed air storage, in particular to systems and methods for heat management for cased wellbore compressed air storage.

### BACKGROUND

Thermal energy management is an engineering challenge for all Cased Wellbore Compressed Air Storage (CWCAS) systems. CWCAS is a type of Compressed Air Energy Storage (CAES) system that is used for energy storage purposes. The challenge originates from compressing air to the maximum storage pressure (Pmax) of the High-Pressure Wellbore (HPWB) unit. This process involves a temperature increase in the compression train causing a reduction in the system's cycle efficiency and potential damage to the compression train machinery, such as air compressors.

For the Cased Wellbore Compressed Air Storage configuration, the released air from HPWB units must be re-heated for the energy recovery process in the expansion train to avoid chilling and freezing. It is a common practice to use fuel from an external separate source, such as natural gas, for a combustion process to generate heat applied to the air expansion train, but this reduces the system's overall cycle efficiency. This type of Compressed Air Energy Storage (CAES) system is classified as a diabatic CAES system, where the heat generated during the air compression process is not recovered nor recycled, and instead, released to the atmosphere. Furthermore, in a diabatic system, the heat required for the expansion train is typically added from a separate source.

Therefore, it is desired to provide a more energy-efficient and environmentally sound CWCAS system.

### SUMMARY

In the present application, the system is configured to recover various grades of heat from: (a) heat generated during the gas compression train, (b) heat generated by recompression of gases entering the high-pressure wellbore (HPWB) units, and (c) heat within the geological medium surrounding HPWB units.

The heat management in the system provides a source of heat that is required during the expansion train and electrical energy-power generation from compressed gas. As such, the system enables co-generation of electricity and heat with high energy efficiencies. The recovered heat (from the compression train) can be stored (as necessary) and then utilized to increase the overall efficiency of the CWCAS system by reusing the heat on the expansion train and/or for other useful purposes.

Reusing the recovered heat reduces or removes the required external fuel-heat source on the expansion train for compressed air expansion, which allows the CWCAS system to be partially and fully adiabatic. Operating the system under (near) adiabatic conditions minimizes greenhouse gas emissions over the system's life cycle and increases its overall cycle efficiency.

The system is configured to create its own geothermal system around the HPWB storage vessels that can be used for reheating a compressed air energy storage system, rather than solely relying on using an existing natural geothermal system with natural occurring hot dry rock for reheating a compressed air energy storage system. In the system of the present application, heat from the HPWB units is conductively transferred to the surrounding rock formation creating a geothermal system around the units. The HPWB units can be installed in an array with a configuration to maximize heat conservation from the HPWB units into the surrounding subsurface rock. In an aspect of the invention, the system may recover heat from the geothermal system using a borehole heat exchanger (BHE) system.

In an aspect of the present application, there is provided a system for storing energy in a form of compressed gas, comprising: one or more energy storage vessels for storing compressed gas, said energy storage vessels each comprising: a wellbore provided in a subsurface; and a casing placed within the wellbore and cemented to surrounding rock formations, the casing defining a volumetric space for storing the compressed gas; and an induced geothermal reservoir is formed in the surrounding rock formations of the one or more energy storage vessels for underground thermal energy storage, whereby a portion of thermal energy of the compressed gas stored in the one or more storage vessels is conductively transferred to, via the one or more storage vessels, the surrounding rock formation, and stored in the surrounding rock formation as heat.

In another aspect of the present application, there is provided a system for heat management that recovers various grades of heat, comprising: one or more wellbore energy storage vessels configured to: store a portion of heat generated during a gas compression stage; store a portion of heat generated by recompression of gases being injected into wellbores of the one or more wellbore energy storage vessels; and recoverably transfer a portion of heat stored in compressed gas from the wellbores to surrounding geological medium surrounding each of the one or more wellbore energy storage vessels for creating a geothermal system around one or more wellbore energy storage vessels.

In a preferred embodiment of this invention, the heat management system facilitates the recovery and storage of various grades of heat (as disclosed hereinabove) produced throughout the air or gas compression and storage processes, for the subsequent purpose of providing heat to an expansion process to generate electricity. The disclosed heat management system as contemplated herein can also be used for other processes that generate recoverable heat.

### BRIEF DESCRIPTION OF THE DRAWINGS

Reference will now be made, by way of example, to the accompanying drawings which show example embodiments of the present application, and in which:

FIG. 1 is a diagram illustrating a heat exchange process in a CWCAS system, according to an embodiment of the present application;

FIG. 2 is a cross-sectional view of a High-Pressure Wellbore (HPWB) in FIG. 1;

FIG. 3A-3C are diagrams illustrating exemplary HPWB configurations for recovering heat of hot compressed air stored in the HPWB, according to example embodiments of the present application;

FIG. 4 is a diagram illustrating a geothermal reservoir produced with CWCAS system in FIG. 1, according to another example embodiment of the present application;

FIG. 5 is a diagram illustrating changes of compressed air temperature with different initial surrounding ground temperature;

FIG. 6A is a diagram illustrating an example configuration of recovering geothermal energy with a Borehole Heat Exchanger (BHE) in the field of HPWB units, according to another embodiment of the present application;

FIG. 6B is a top view of a single U-tube BHE of FIG. 6A;

FIG. 7 is a diagram illustrating a heat exchange process in a CWCAS system, according to another embodiment of the present application;

FIG. 8 is a diagram of a CWCAS configuration for recovering heat of compression with a packed bed regenerator, according to another example embodiment; and

FIG. 9 is a diagram of a CWCAS configuration for recovering heat of compression with synthetic oil, according to another example embodiment.

Similar reference numerals may have been used in different figures to denote similar components.

### DESCRIPTION OF EXAMPLE EMBODIMENTS

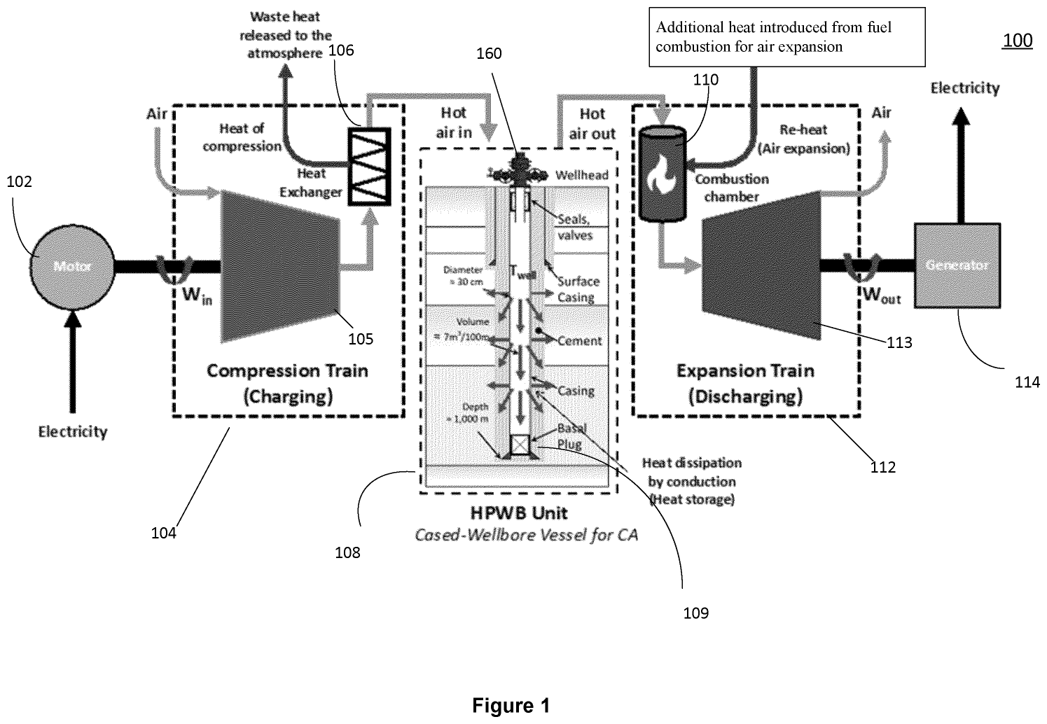

FIG. 1 illustrates an exemplary CAES system 100 that stores energy from a renewable energy source or other energy sources with excess energy using compressed air and HPWB units. This CWCAS system 100 comprises a Compression Train 104, a HPWB array 108, and an Expansion Train 112. In the present application, the compressed gas includes compressed air and both terms may be used interchangeably.

In the example of FIG. 1, excess energy, such as electricity, is used to drive a motor 102 of the compression train 104. Although the compression train 104 in FIG. 1 only illustrates one compressor 105, the compression train 104 may include one or more compressors 105. By compressing the air, the compression train 104 stores at least a portion of the excess energy in the compressed air.

The compression train 104 generates heat during the air compression process, referred to as a charging cycle. In FIG. 1, compression train 104 may include a heat exchanger 106. The heat exchanger 106 is configured to collect and store the heat generated by the compression train 104 during the air compression process. The heat exchanger 106 can be used to recover a portion of the heat from the compressor 105, such heat being generated from the air compression process. When the heat from the compressor 105 flows through the heat exchanger 106, by heat exchange, such heat is recovered and can be stored separately for subsequent use. Some of the heat of compression remains in the hot compressed air and is then stored in one or more HPWB units 109 of HPWB array 108. As such, a portion of the heat of compression is retained in the compressed air that is stored inside HPWB units 109 at T_{well}, such as 200 to 350° C., depending on the temperature configuration of the HPWB units 109. This medium-grade heat is recoverable directly from the hot compressed air stored in the HPWB units 109 and can be utilized in the expansion train process 112.

Furthermore, when the compression train 104 outputs the compressed air at a first pressure, the system 100 is configured to inject the compressed air into the HPWB 109 at a second pressure lower than the first pressure. As such, the injected compressed air into the HPWB 109 undergoes a recompression stage as the compressed air fills and pressurizes the well. This secondary recompression process causes an additional temperature increase of the compressed air stored in the HPWB 109, and therefore improves the storage of heat in the HPWB units 109. For example, the system 100 may include at least one gas flow regulator configured to inject the compressed gas from the compression train 104 into the HPWB 109 and said gas is at a first pressure higher than a second pressure inside the HPWB 109 before the compressed gas is injected into the HPWB 109; and retains heat generated during this injection process within the HPWB 109.

Although the HPWB array 108 in FIG. 1 only illustrates one HPWB unit 109, the HPWB array 108 can include one or more HPWB units 109. The HPWB array 108 is used to store hot compressed air output from the compression train 104 and to subsequently output the stored hot compressed air to the expansion train 112. The expansion train 112 is configured to expand the compressed air from the one or more HPWB units 109 in the HPWB array 108, so that the energy stored in the compressed air is discharged to drive a generator 114, which in turn generates electricity. This process is referred to as a discharging cycle. System 100 includes a heat exchanger 110 for further heating of the hot air output from the HPWB array 108 during the discharging cycle, with such heat coming from one or more external heat source. In the example of FIG. 1, the heat exchanger 110 comprises a combustion chamber using fuel for further heating of the hot air. The heated air may then be input to the expansion train 112 from the heat exchanger 110. The cooling effect of high pressure air and other gases, as stored in one or more HPWB units 109, as it is discharged to lower pressures in the expansion train 112, and the need to re-heat such air flow, are well understood by a person skilled in the art. Although the expansion train 112 in FIG. 1 only illustrates one expander 113, the expansion train 112 may include one or more expanders 113 and one or more heat exchangers 110.

For CWCAS, compressed air is stored in one or more HPWB units 109, typically during periods of low energy demand. The stored compressed air is released during higher-demand periods of energy to operate expanders 113, which may be turbine-style or reciprocating engines, for electricity generation. The CWCAS system 100 may also feed natural gas or hydrogen (or mixed) combustion turbines, along with a train of air expanders 113, which may be reciprocating or turbine in nature. In system 100, one or more properly designed and drilled deep cased wells are used as a HPWB unit(s) 109 for HPWS of compressed air. The HPWB unit(s) 109 is configured to meet the requirement to operate at conditions of high pressure on the order of 25-100 MPa and high temperature up to 350° C.

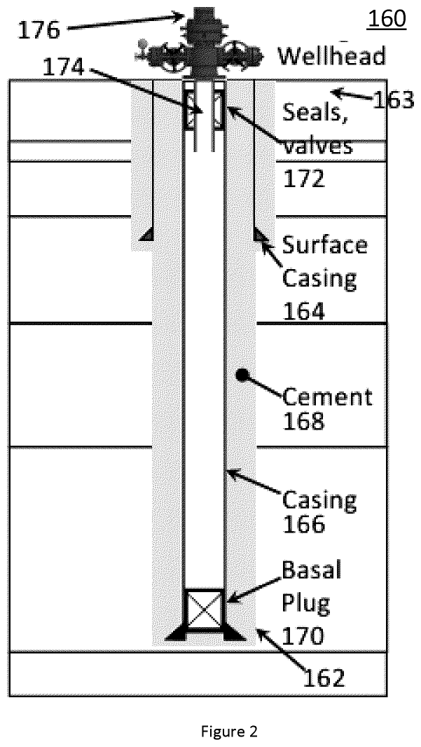

FIG. 2 illustrates a cased wellbore vessel 160 as a detailed example of HPWB 109 in FIG. 1. The cased wellbore vessel 160 may be a wellbore 162 cased with material that can sustain high pressure and high temperature. For example, the wellbore 162 may be cased with a casing 166 made from high-grade steel, such as P110 or Q125 grade casing. In an embodiment, such wellbore casing 166 is a high-grade steel rated to high pressure up to 100 MPa and high temperature up to 350° C. Cement 168 can be used to cement the casing 166 with the surrounding rock formations.

In the example of FIG. 2, the wellbore 162 may be a vertical wellbore formed by drilling into subsurface formations 163. The cased wellbore vessel 160 may be a high pressure-high temperature (HP-HT) well by drilling the wellbore 162 to a depth, such as at least 500 meters and casing the well with HP-HT rated casing 166, wellhead 176, and cement 168. In some examples, the well 16 may have a depth of up to 1500 meters. The depth of a well can vary depending on the volumetric capacity of the well required for energy storage specifications in a given application. In an embodiment cased wellbore vessel 160 has a depth of at least 500 m to 1500 m. In some examples, multiple sections of casing 164, 166 may have progressively smaller diameter casing as the wellbore length is extended.

The wellbore 162 may be drilled in substantially any type of rock or sediment. Oilfield rotary drilling technology may be used to drill a HP-HT wellbore in sedimentary rock. Air hammer drilling may be used to drill a HP-HT wellbore, providing for more rapid drilling in dense, low permeability rocks such as granites or very dense sediments.

Cement 168 is designed for the temperature and pressure range of the CWCAS operation, for example based on mathematical modeling of casing 166 and the stiffness of the rock mass. The casing 166 and the cement 168 are corrosion resistant.

Due to the depth of the cased wellbore vessel 160 in the subsurface formations 163, the compressed air stored within the well 16 may be able to sustain a temperature up to and exceeding 350° C. at a well depth of up to 1500 meters.

An air-tight basal plug 170 may be installed at the bottom end of the casing 166 and an air-tight top seal or valve 172 may be installed at the top portion of the casing 166, for example at 20-50 meters beneath the ground surface. The casing 166, the basal plug 170, and the top seal 172 define an air-tight volume or space for storing the compressed air within cased wellbore vessel 160. In some examples, the basal plug 170 may be omitted and the casing 166 is otherwise sealed at the bottom end. The top seal 172 is configured to accommodate tubing 174 through which the compressed air may be injected into or discharged from the storage vessel 16. In an example, the tubing 174 may have a diameter of 15 cm or less.

A high-pressure wellhead 176 caps the casing 166 and the tubing 174. The wellhead 176 is designed to allow the injection of the hot compressed air into the well 16 and discharge the hot compressed air from the cased wellbore vessel 160. The tubing 174 is air-tightly connected to the wellhead 176. The wellhead 176 may be a manifold having one or more valves or air flow regulators that allows the cased wellbore vessel 160 to be properly managed. In some examples, the manifold may, for example, by turning on or off the valves, selectively allow the compressed air from the air compressor 14 to inject into the well 16 through the tubing 174 for storage. In some examples, the manifold 176 may, for example by turning on or off the valves, selectively allow the stored compressed air to be discharge from the cased wellbore vessel 160, through the tubing 174, to the expansion train 112.

Because of the in situ confinement, the casing 166 may take pressures up to 100 MPa with negligible safety risk because the entire storage vessel 16 is under the ground, and since the top seal and the safety valves are located below the ground surface, for example at about 25 meter depth.

In some examples, the internal diameter of the casing 166 is about 30 cm. The diameter of the casing of the well can vary depending on the volumetric capacity of the cased wellbore vessel 160 required for energy storage specification in a given application. In an embodiment, the volumetric capacity of the cased wellbore vessel 160 is 7 m³ per 100 meter length of the well 16 with a total depth of 1000 m, with an air pressure of 50 MPa and a temperature up to 350° C. In this example, each cased wellbore vessel 160 may store compressed air that may store up to 10 MWh of energy for electricity generation. In one example, the energy stored in the compressed air with a conservative pressure of 25-50 MPa stored up to 350° C. in a single storage vessel or well 16, which casing 166 has a diameter of 30 cm and a depth of about 1000 meters, may be in the order of 5-10 MWh of energy.

The amount of energy stored in the compressed air in one HPWB unit 109 depends on the volume of the cased wellbore vessel 160, and pressure range of the compressed air stored therein. The temperature of air is also critical in energy production. The temperature range of storage is from 50-350° C. The total volume of the cased wellbore vessel 160 may typically be 20-100 m³, the depth of the cased wellbore vessel 160 may be up to 2000 meters (or deeper), the pressure of the compressed air stored in the well 16 may be 5 MPa to 100 MPa, and the temperature of the compressed air stored the cased wellbore vessel 160 may typically be 50° C. to 250° C. Although in these examples, the cased wellbore vessel 160 is assumed to be vertical in orientation, the actual well profile may be inclined or horizontal as required by a particular application. The volume and depth of the cased wellbore vessel 160 can vary accordingly.

Heat of various grades is available from the charging-discharging cyclic operation of the CWCAS system 100. High-grade heat typically refers to the heat greater than 200° C., mid-grade heat is typically at temperatures 100° C. to 200° C., and low-grade heat typically refers to the heat less than 100° C. The systems 100 may include multiple heat management mechanisms to improve energy storage and recovery efficiency.

In an embodiment, within the compression train 104 of the system 100, the compressor(s) 105 withdraw air from the atmosphere and compress the air to a pressure (Pmax) suitable for storage in the HPWB unit 109, typically on the order of 50 MPa. The pressure may be higher, such as 50-200 MPa, or lower than 50 MPa, such as 10 MPa-50 MPa, based on energy storage needs. As a result of the compression, the air temperature increases significantly, producing high-grade heat for recovery and storage. This compression process generated heat is also called heat of compression.

The temperature of the compressed air is reduced to the required storage temperature (T_{well}) of the HPWB unit 109. The heat exchanger 106 may adjust the temperature of the compressed air to the storage temperature (T_{well}), such as approximately 200° C. The temperature of the compressed air may be higher such as 200° C.-350° C., or lower, such as 100° C.-200° C., depending on energy storage needs and temperature configuration of HPWB unit 109.

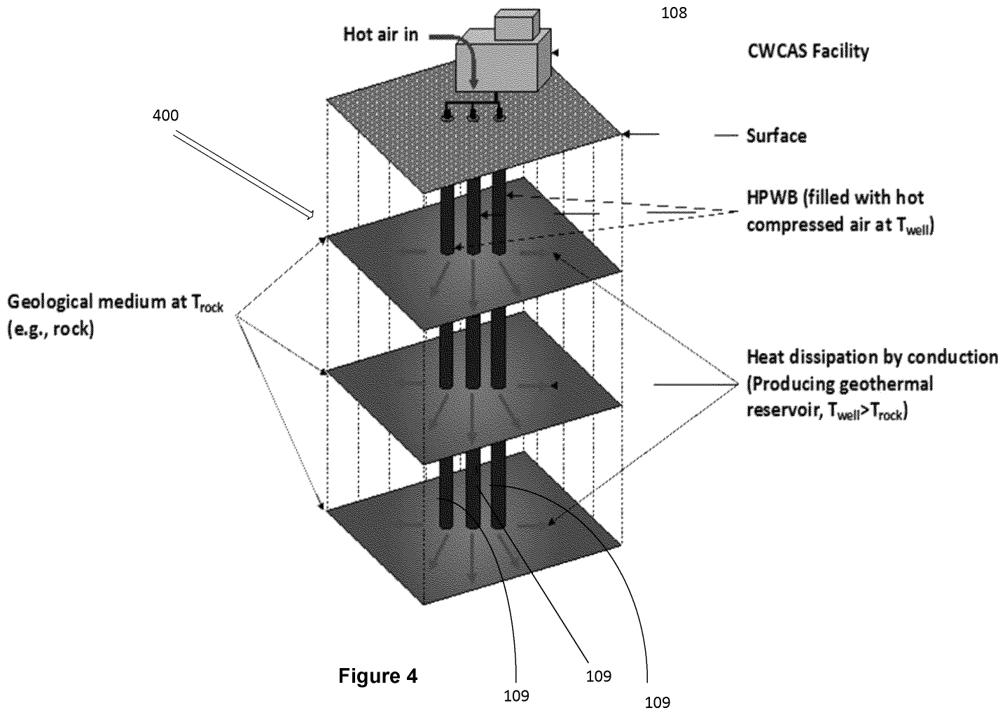

As such, the system 100 is an overall high-temperature system. The heat of the compressed air in the HPWB units 109 can be used to directly supply the thermal energy required for air expansion on the expansion train 112, by inputting the hot compressed air from the HPWB units 109 directly into the expansion train process 112. This direct heat supply embodiment may be used for a situation where only a relatively shorter storage period has elapsed, such as 5 to 30 hours, before the heat of the compressed air stored in the HPWB units 109 dissipates to the geological rock medium of the geothermal reservoir 400 (see FIG. 4) surrounding HPWB units 109. Hence the storage temperature (T_{well}) of the HPWB unit 109 is still a source of medium to high grade heat.

However, such direct heat supply for the expansion process may be insufficient for, or limited by, the overall expansion train process 112. Hence additional heat sources are required during the expansion process in order to maintain operating efficiencies. Such heat sources are present within the overall system 100 as further described hereinbelow.

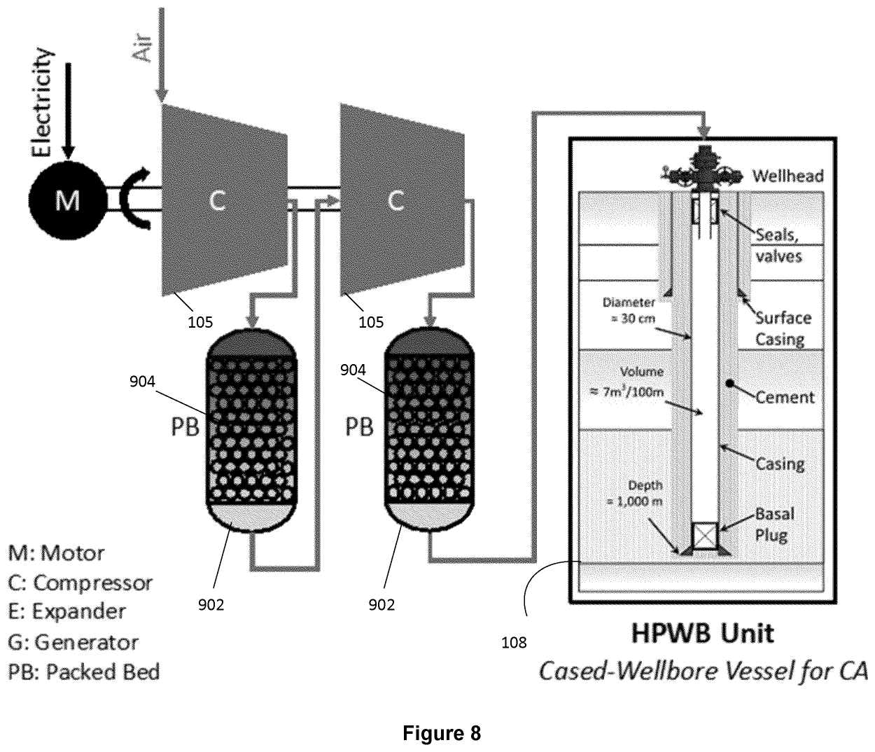

For longer compressed air storage periods, such as greater than 30 hours, in the HPWB units 109, or array 108, it may be necessary to recovery the heat of compression and store it separately in a thermal energy storage system. As will be described in greater detail in FIG. 8, the heat of compression may be recovered, stored and subsequently used to supply the thermal energy required for air expansion on the expansion train 112.

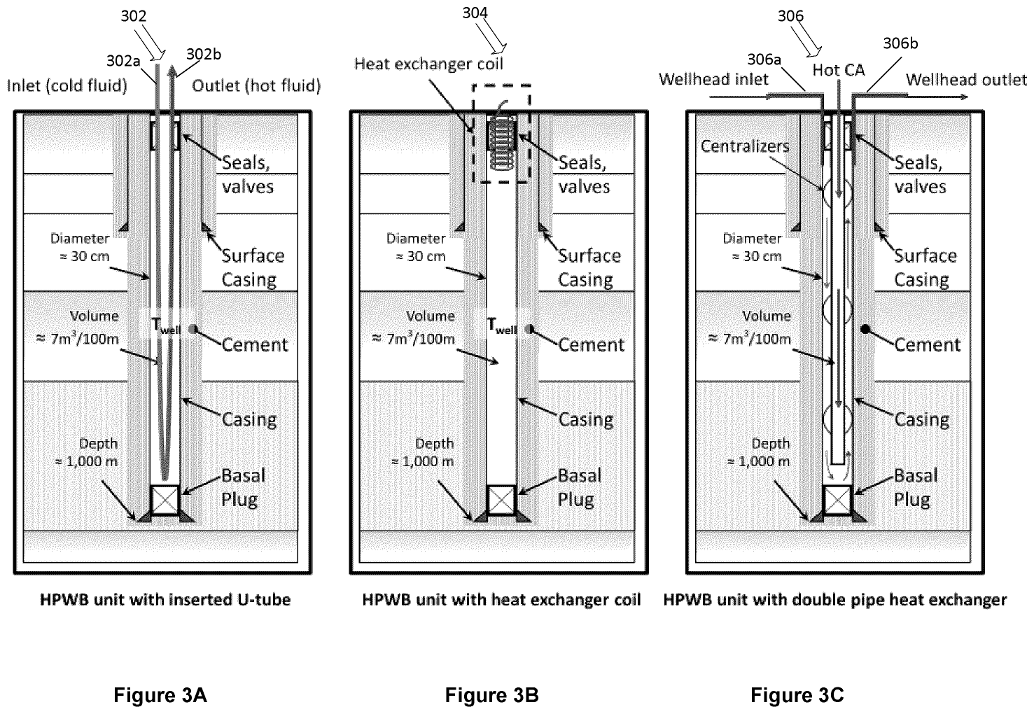

In some cases, the heat of compression of the compressed air can also be used for other useful purposes. It is necessary to recover heat directly from the stored hot compressed air stored in the HPWB array 108, and an apparatus allowing the heat exchange, typically by conduction is required. In some preferred embodiments, to recover heat directly from the hot compressed air stored in the HPWB array 108, the HPWB units 109 may be configured to include a wellbore heat exchanger apparatus which allows heat exchange typically by conduction. The thermal energy that can be extracted or collected via the wellbore heat exchanger systems and used as a heat source for the expansion train 112 in an air expansion process for generating electricity or other heating applications. FIGS. 3A-3C illustrate examples of heat exchangers within the HPWB unit 109. In FIG. 3A, the system 100 may include a U-tube convective circulation system 302 inside an HPWB unit 109. The tube convective circulation system 302 is inserted into the HPWB unit 109, and is filled with circulating heat exchange fluid for heat exchange with the hot compressed air in the HPWB unit 109. As such, colder fluids (T_{fluid}<T_{well}) are injected at the inlet 302a of the tube and circulated down the HPWB unit 109 recovering heat from the hot air in the HPWB unit 109. As the circuit continues along the U-tube system 302, heat is recovered such that a hotter fluid exits the outlet 302b of the tube. In FIG. 3B, the HPWB 109 may include a heat exchanger coil 304, which can exchange heat with the hot compressed air stored in the HPWB unit 109. In FIG. 3B, the HPWB 109 may include a heat exchanger coil 304 securely mounted around the top seal 172. The heat exchanger coil 304 can exchange heat with the hot compressed air sealed in the HPWB unit 109 with the environment outside the HPWB 109, such as the heat exchanger 110. In FIG. 3C, the HPWB 109 may include a double pipe heat exchanger configuration. The inner tubing 174 runs to the bottom of the HPWB unit 109 and is sealed. The inner tubing 174 may also be insulated at the top portion, such as about 50 m from the surface. The inner tubing 174 is securely mounted around the top seal 172 and wellhead 176. The inner tubing 174 receives the hot compressed air from the compression train 104. The double pipe heat exchanger configuration 306 requires that there be an inlet 306a and an outlet 306b to the annulus of the HPWB unit 109 between the inner tubing 174 and the casing 166. The inlet 306a receives cold fluid (T_{fluid}<T_{well}) for flowing into the annulus portion of the HPWB unit 109 and in contact with the hot compressed air in the inner tubing 174 to exchange heat. With the heat exchange with the hot air in the tubing, the fluid in the annulus becomes hot. The annulus side circulates cold fluid in and then output hot fluid at the outlet 306b to a separate surface heat exchanger, such as the heat exchanger 110. In one example, a density drive effect between the cold and hot fluid in the annulus helps with circulation. In the examples of direct heat recovery as per FIGS. 3A-3C, the hot fluid flows out of the HPWB unit 109 from the outlet 306b, for supplying heat for other applications such as to the expander 113 via the heat exchanger 110. FIGS. 3A and 3C are examples of different configurations for double pipe heat exchangers; other heat exchange configurations can also be contemplated for the invention herein.

In some examples, the heat recovery from heat of compression can be used for other useful purposes, for example, for space and water heating.

In some examples, a portion or most of the heat recovery from the heat of compression can be supplied to a power unit, such as an organic Rankine cycle (ORC) engine, to generate power directly. The generated power by the power unit can provide a portion or most of the energy needed for the air compression process 102, thereby improving the overall efficiency of the system 100

The system 100 is predicated on creating its own geothermal system for UTES, around the CWCAS storage wells or HPWBs 109 that can be used for reheating a compressed air energy storage system. In the example of FIG. 4, in the system 100, the site of HPWB 108 may be selected at suitable geological locations to create an induced geothermal reservoir 400 for Underground Thermal Energy Storage (UTES). The geothermal system may be used as a source of low-grade heat; and also (over time) develop around the HPWB 108 for providing an insulating effect for the hot compressed air stored in the HPWB 108.

As described above, the system 100 operates in a cycle of charging (air compression) and discharging (air expansion) with a storage period in between charging and discharging. FIG. 4 illustrates an example of HPWB 108 located at a selected geological medium to create the induced geothermal reservoir 400. Geological medium refers to the type of rock formation(s) that surround the HPWB units 109. In some examples, the geothermal reservoir 400 may comprise the geological medium having a thermal conductivity range of 0.25 W/m·K for soils to somewhat over 4.0 W/m·K for granites and quartzites. During the storage period, if T_{well}>T_{rock}, where T_{well} is the temperature of HPWB units 109 and T_{rock} is the temperature of the subsurface rock formation, the heat stored in the hot compressed air in the HPWB units 109 gradually diffuses away from the HPWB unit 109 by conduction to the surrounding subsurface rock formation and thereby creating a geothermal reservoir 400 for UTES. The longer the storage period, the more heat dissipation to the surrounding subsurface rock formation can occur. As the cycle continues over time, the accumulated thermal energy in the rock mass creates a low-grade geothermal reservoir 400 for UTES.

In the example of FIG. 4, if local groundwater flow is present at the geological location, the heat dissipation away from the HPWB unit 109 to the surrounding ground may take place at an accelerated rate by convective heat transfer.

In an aspect, the system 100 may include one or more energy storage vessels or HPWB units 109 for storing compressed gas forming a HPWB array 108. The energy storage vessels or HPWB units 109 each comprises: a wellbore 162 provided in a subsurface 163, a casing 166 placed within the wellbore 162 and cemented to a surrounding geological medium, such as rock formations, the casing 166 defining a volumetric space for storing the compressed gas; and a geothermal reservoir 400 formed at the surrounding rock formations of the one or more HPWB units 109 or energy storage vessels for underground thermal energy storage, wherein a portion of thermal energy of the compressed gas stored in the one or more HPWB units 109 or storage vessels is conductively transferred to the surrounding rock formation, and stored in the surrounding rock formation as heat.

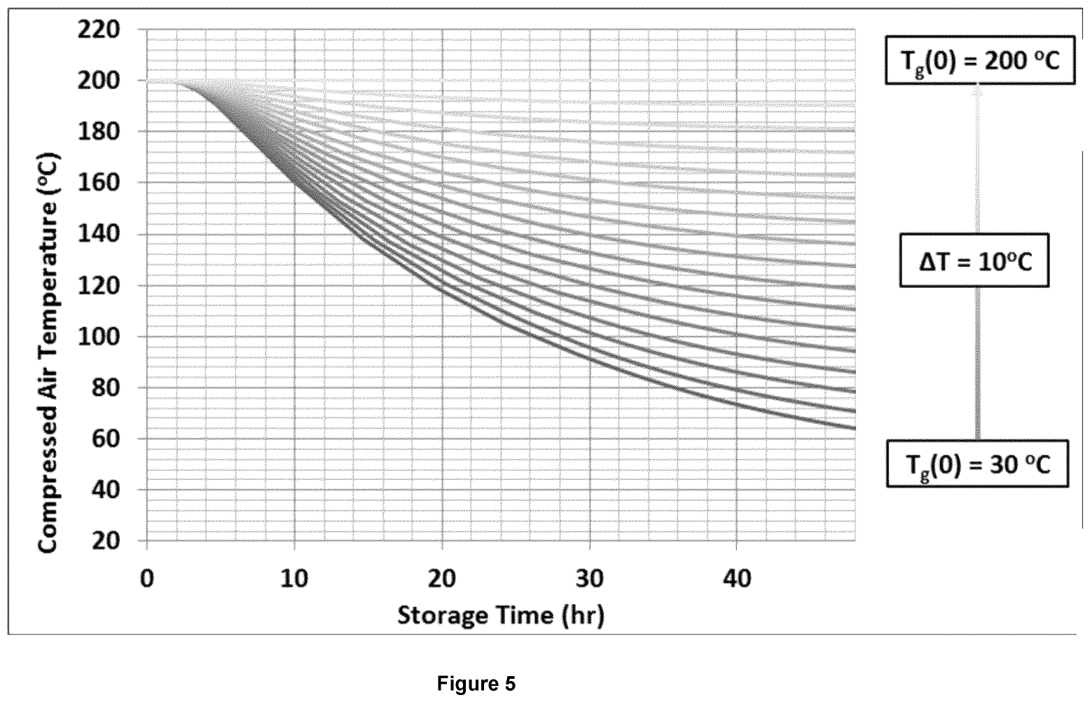

The rate of heat dissipation is also dependent on the temperature of the surrounding rock. FIG. 5 illustrates the theoretical compressed air temperature changes over time in the HPWB unit 109 with different initial surrounding ground temperature. In FIG. 5, Tg is the ground temperature. As illustrated in FIG. 5, the initial temperature of compressed air is 200° C. When Tg=200° C., the temperature of compressed air in the HPWB unit 109 maintains the same initial temperature of 200° C. over time. If the Tg is less than the initial temperature of compressed air in the HPWB unit 109, the temperature of compressed air decreases by heat conduction to the surrounding geological medium. If the temperature difference between the compressed air in the HPWB 109 and Tg is greater, the decrease of the temperature of the compressed air in the HPWB unit 109 is faster. A similar approach can also be used to assess the thermal storage performance of multiple HPWB units 109 in a HPWB array 108.

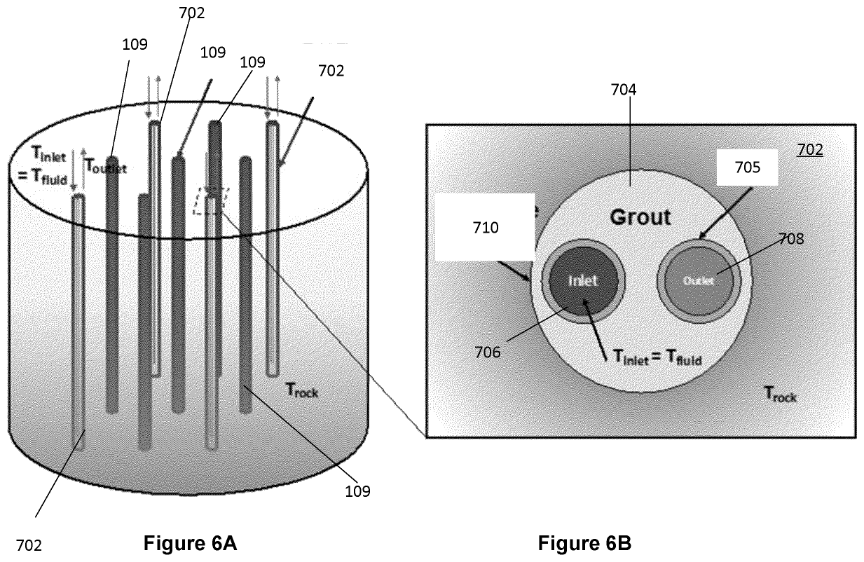

As well, the stored thermal energy in the geothermal reservoir 400 can be extracted or collected and used as a low grade heat source for the expansion train 112 in an air expansion process for generating electricity or other heating applications. FIG. 6A illustrates an example of recovering geothermal energy with Borehole Heat Exchanger (BHE) in the surrounding area of HPWB 108. As illustrated in FIG. 6A, one or more BHEs 702 in boreholes are placed around the HPWB units 109, for example with 5 to 10 meters spacing, although other spacing distances can be used based on the application. The stored thermal energy in the geothermal reservoir 400 can be extracted with the BHEs 702.

FIG. 6B illustrates a plan view of a single U-tube BHE 702 assembly. The BHE 702 consists of a borehole 710 and a heat exchange pipe 705 is inserted inside each borehole to allow fluid circulation. The gap between the pipe and the borehole wall is filled with grout 704 to allow conductive heat transfer from the ground surrounding the HPBW units 109 to the fluid inside the pipe 705.

Boreholes 710 are drilled through a selected target thermal reservoir 400 in the vicinity of the HPWB units 109. A heat exchange pipe 705 is inserted inside each borehole 710. The pipe 705 has an inlet 706 for receiving fluid with a temperature T_{fluid in}, and an outlet 708 for releasing fluid with a temperature T_{fluid out}.

In some examples, T_{fluid in}<T_{borehole} (or T_{rock}.). The colder fluid circulates in the pipe 705 placed in the borehole 710. The gap between the pipe 705 and the borehole wall 710 is filled with grout 704 to allow conductive heat transfer from the ground surrounding the HPBW units 109 to the fluid. The fluid flows out from the outlet 708 of the pipe 705 with a higher temperature T_{fluid out}>T_{fluid in}. due to conductive heat transfer from the ground surrounding the borehole 710. As such, the heat can be recovered from the ground surrounding the HPBW units 109.

In an embodiment for use of the BHE system, for recovering heat, cold fluid is injected at the inlet 706 of the pipe 705 inside BHE 702 whereby T_{rock}>T_{fluid}; and in another embodiment further described below, for storing heat, the heat exchange fluid can be heated at the surface and injected at the inlet 706 of the pipe 705 whereby T_{rock}<T_{fluid}.

In some examples, the low-grade heat recovered from the BHE 702 or geothermal reservoir 400 400 can be used for space and water heating purposes.

Furthermore, the BHE 702 can be installed and connected as a geothermal ground loop installed to connect multiple boreholes 710 for exchanging heat in the geothermal reservoir 400 surrounding the HPBW array 108 with heat exchangers 110 or with thermal energy storage systems at surface 120.

In some examples, the system 100 can also use other waste heat recovery technologies to extract heat from the UTES in the geothermal reservoir 400, including heat pumps, organic Rankine cycle, or Kalina cycle processes. These technologies are suitable for recuperating heat and converting part of the thermal energy therein to useful thermal and electrical energy.

In some examples, the geothermal reservoir can accommodate and store heat from additional sources, such as solar thermal collectors or waste heat from a manufacturing plant.

In some examples, the BHE 702 may be used to store heat in the geological medium 400. In this case, the heat exchange fluid heated at the surface is injected to the pipe 705 via the inlet 706 at T_{fluid in}>T_{borehole} (or T_{rock}.). The fluid flows out from the outlet 708 of the pipe 705 with a lower temperature T_{fluid out}<T_{fluid in}. due to conductive heat transfer to the ground surrounding the borehole 710.

The development of the geothermal reservoir 400 during the CWCAS system 100, and its heat recovery process performance is dependent on several design factors and parameters for the geological medium. These factors and parameters ultimately affect the efficiency of the UTES system.

The most critical parameters related to the surrounding geological medium are thermal conductivity and thermal capacity, as these parameters govern the heat storage capacity of the rock and the rate of heat flow in the rock. Moisture content and porosity of the geological medium contribute to the thermal properties of the geological medium. The presence of groundwater and its flow rate also influence the UTES performance of the geothermal reservoir 400.

Furthermore, the design and construction of the HPWB units 109 will affect the maximum temperature for the stored compressed air. The design and construction of the HPWB units 109 need to account for the degree of insulation needed in the well to retain heat in the wellbore. The well design factors affecting such performance include thermal properties of the well construction materials (e.g., casing and cement) and well geometry (e.g., depth, diameter, volume). Hence, well design and construction of the HPWB units 109 can affect the efficiency and performance of the geothermal reservoir 400 for UTES.

Using the appropriate mathematical models that consider such factors, FIG. 5 shows change of stored temperature inside a HPWB unit 109 over time for different initial surrounding ground temperature.

Furthermore, the deep cased wellbore vessel 160 used for the CWCAS can be either a single HPWB unit 109 or several HPWB units 108 comprising an array of cased wellbore vessels 160. Under certain embodiments, several distinct arrays can also be used as part of the CWCAS system 100.

With regards to the capacity of the geological medium to provide a viable geothermal reservoir 400 for UTES, the well array factors to be considered include: number of wells, well spacing, array area and size, and array geometry or pattern.

An appropriate well spacing and array pattern needs to be determined to mitigate the negative consequences of thermal interaction between cased wellbore vessels 160.

A well array with a lower surface-area-to-volume ratio, for example an array over a smaller area, such as 25 m²/well, with several wells, such as 5 or more wells, at well depths greater than 500 m, is desired for improved efficiency of heat accumulation.

Other operational parameters, such as (but not limited to) discharge time, storage duration, and recharge time, and the order of charging and discharging of wells are also related to the performance of the integrated systems 100 and geothermal reservoir 400. Appropriate mathematical models may be used to assess and select the factors and operational parameters for the design of well arrays 108 to optimize the heat management performance of the integrated systems 100 and geothermal reservoir 400.

Furthermore, as the charging and discharging cycle(s) of system 100 continues, in which cycle durations can be on the order or hours, days or weeks, the heat loss from the compressed air in the HPWB units 109 to the surrounding ground is significantly reduced, due to the increased temperature of the geological medium of the geothermal reservoir 400 over time. This also improves the hot compressed air storage capacity in the HPWB units 109. The heated geological medium of the geothermal reservoir 400 functions as a thermal insulator that prevents the compressed air in the HPWB units 109 from losing its thermal energy. This scenario improves the hot compressed air storage capacity in the actual wells 160 during the CWCAS process.

As well, appropriate mathematical models which consider geothermal parameters, discharge time, storage duration, recharge time, and the order of charging and discharging of HPWB units 109, may be used to select and assess the use of the geological medium as a viable geothermal reservoir 400 for UTES and to optimize thermal efficiencies of system 100.

Using such an appropriate mathematical model that considers such factors, FIG. 5 shows change of temperature of stored compressed air inside a HPWB unit 109 over time for different initial surrounding ground temperature. A similar approach can also be used to assess the thermal storage performance of multiple wells in a HPWB array 108.

By determining appropriate parameters for the geological medium, HPWB units 109, HPWB array 108, the overall efficiency and flexibility of heat management process for the system 100 and system 150, to be described below, can be optimized and improved to recover, store and utilize heat generated by the system 100.

If the heat of compression is successfully recovered from the CWCAS system 100 and stored for use in the expansion train, the cycle efficiency of system 100 can be significantly improved. The term “adiabatic CAES system” is used to describe a CAES system where a sufficient amount of heat generated during the compression process is recovered in the system and reused for air expansion in the expansion train 112, thereby eliminating external fuel requirements. For a low volume, high pressure, and high temperature CAES system, such as the CWCAS system, an adiabatic system or a partial adiabatic system is advantageous, as it is more energy-efficient and environmentally sound compared to a diabatic system. The recovered heat may also be used for other purposes as well, such as space heating, drying, habitats, etc., depending on the grade of the heat.

Using the heat management systems described hereinabove, it is thus desirable for a CWCAS system 100 to include a more efficient heat management system that facilitates recovery, storage, and utilization of various grades of heat produced throughout its air compression and storage processes. Incorporating such a heat management system allows the CWCAS system to achieve adiabatic operating conditions, enhancing the overall efficiency, safety and versatility, and further reducing its environmental impacts. The CWCAS system 100 may also be partially adiabatic. In such a case, some of the heat required for the expansion train 112 comes from the compression and heat management processes described herein, and some of the heat required for the expansion train 112 comes from a separate source, such as combustion of fuel.

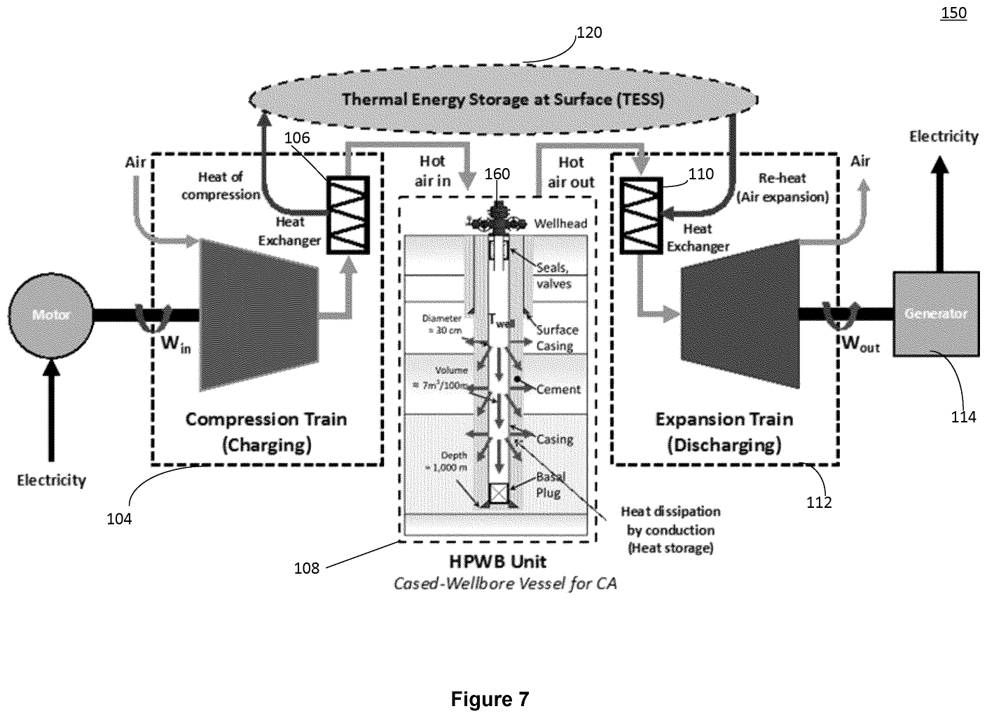

According to an embodiment, FIG. 7 illustrates an exemplary adiabatic or partial adiabatic CAES system 150, as the system 150 uses captured heat for the expansion train 112, without or with less additional externally sourced fuel required for combustion as a heat source for the expansion train 112.

The system 150 is the same as system 100 described above except that system 150 includes a thermal energy storage at surface (TESS) 120. As illustrated in FIG. 8, extra high grade heat of compression captured by the heat exchanger 106 at the compression train 104 is stored in the TESS 120, and the TESS 120 is configured to supply such heat to the heat exchanger 110 at the expansion train 112. As such, the system 150 better uses the heat generated during the air compression process, and thus is more energy efficient than system 100. In an embodiment, some of the high-grade heat captured in the TESS 120 can also be used for other purposes such as district heating, space and water heating purposes.

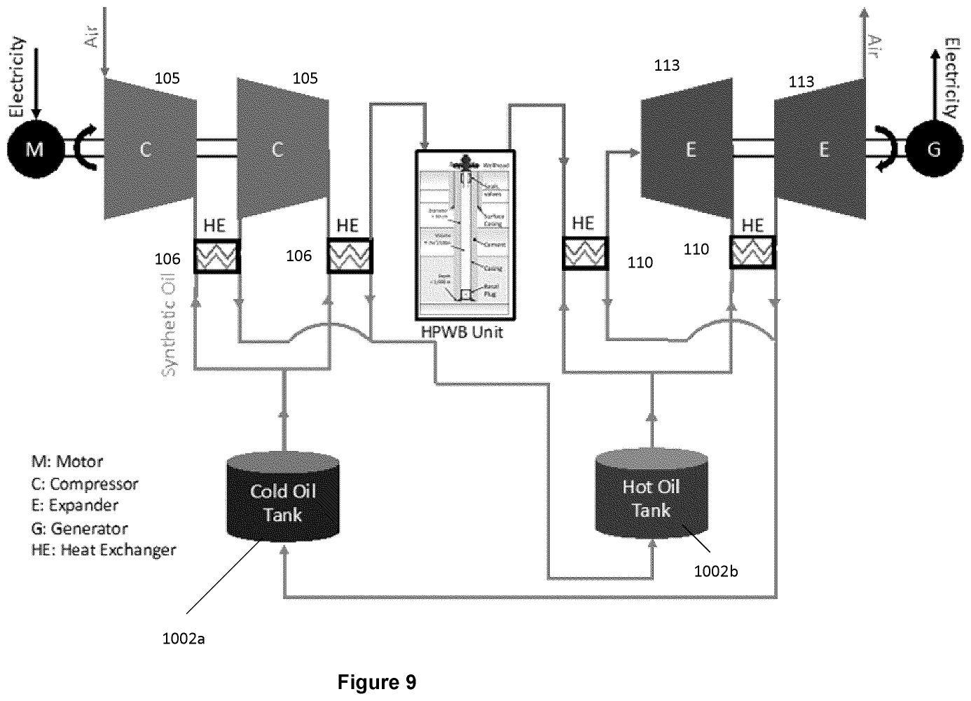

Capturing the high-grade heat of compression is feasible with a direct TESS 120, such as packed bed regenerators 902 illustrated in FIG. 8, or with an indirect TESS 120, such as oil tanks filled with synthetic oil illustrated in FIG. 9.

In FIG. 8, the packed bed regenerator 902 is a direct contact TESS. As the hot compressed air output from the compressor 105 passes directly through the packed bed regenerator 902, porous solids or gravels 904 contained inside the regenerator 902 absorb a portion of the heat of compression for storage in TESS 120. The regenerator 902 supplies the stored heat to the compressed air at heat exchanger 110 in the expansion train 112.

In FIG. 9, the oil tanks 1002a and 1002b is an indirect contact TESS 120. The hot compressed air from the compression train 104 and cold synthetic oil in cold oil tank 1002a undergo a heat exchange process within a number of heat exchangers 106, such as intercoolers on the compression train 104. The heated oil is then transported and stored for a short term inside a hot oil tank 1002b. The heated oil inside the hot oil tank 1002b supplies heat to the compressed air released from the HPWB array 108 at the heat exchanger 110 during an air expansion process at the expanders 113.

The TESS 120 may also include latent TESS with phase change materials (PCM).

The TESS 120 also supports system 150 integrated with a hydrogen power system by capturing the heat of compression and waste heat from hydrogen electrolysis or other hydrogen generation technology.

Certain adaptations and modifications of the described embodiments can be made. Therefore, the above discussed embodiments are considered to be illustrative and not restrictive.

1. A system for heat management that recovers various grades of heat, comprising:
one or more wellbore energy storage vessels configured to:
a. store a portion of heat generated during a gas compression stage;
b. store a portion of heat generated by recompression of gases being injected into wellbores of the one or more wellbore energy storage vessels; and
c. recoverably transfer a portion of heat stored in compressed gas from the wellbores to surrounding geological medium surrounding each of the one or more wellbore energy storage vessels for creating a geothermal system around one or more wellbore energy storage vessels.

2. A system for storing energy in a form of compressed gas, comprising:
one or more wellbore energy storage vessels for storing compressed gas, the one or more wellbore energy storage vessels each comprising:
a wellbore provided in a subsurface;
a casing placed within the wellbore and cemented to a surrounding geological medium, the casing defining a volumetric space for storing the compressed gas; and
an induced geothermal reservoir formed in the surrounding geological medium of the one or more wellbore energy storage vessels for underground thermal energy storage, wherein a portion of thermal energy of the compressed gas stored in the one or more wellbore energy storage vessels is conductively transferred to, via the one or more wellbore energy storage vessels, the surrounding geological medium, and recoverably stored in the surrounding geological medium to create a geothermal system around the one or more wellbore energy storage vessels.

3. The system of claim 2, further comprising at least one gas flow regulator sealed at a top end of the casing for selectively injecting the compressed gas into the volumetric space or discharging the compressed gas from the volumetric space, wherein injection of the compressed gas into the volumetric space is at a first pressure higher than a second pressure in the volumetric space, and the one or more energy storage vessels retain heat generated during said injection within the volumetric space.

4. The system of claim 2, further comprising at least one gas compression train at surface, the at least one gas compression train having one or more compressors in sealed, fluid communication with the one or more wellbore energy storage vessels, each compressor is configured to compress gas, wherein the gas compression train is configured to store heat generated during a gas compression process in a heat recovery system for thermal energy storage at surface.

5. The system of claim 4, wherein said gas compression train generates heat that is partially stored in the one or more wellbore energy storage vessels.

6. The system of claim 2, further comprising at least one gas expansion train at surface, the at least one gas expansion train having one or more expanders, in sealed, fluid communication with the one or more wellbore energy storage vessels for generating electricity from the compressed gas discharged from the one or more wellbore energy storage vessels, wherein stored thermal energy is configured to be extracted to supply heat to the one or more expanders at the surface in an expansion process.

7. The system of claim 4, wherein the heat recovery system comprises a packed bed regenerator comprising porous solids or gravels contained inside the packed bed regenerator.

8. The system of claim 4, wherein the heat recovery system comprises one or more oil tanks, each oil tank comprising within one or more heat exchangers.

9. The system of claim 4, wherein the heat recovery system comprises phase change materials (PCM).

10. The system of claim 2, further comprising a Borehole Heat Exchanger (BHE) in the surrounding geological medium of the one or more wellbore energy storage vessels for recovering geothermal energy from the induced geothermal reservoir.

11. The system of claim 3, further comprising at least one wellbore heat exchanger to recover heat, using heat exchange by conduction, directly from the compressed gas in the one or more energy storage vessels.

12. The system of claim 11, wherein the at least one wellbore heat exchanger comprises a U-tube convective circulation system inserted inside the volumetric space of the one or more energy storage vessels for transmitting thermal energy of the compressed gas out from the one or more energy storage vessels, and wherein the U-tube convective circulation system is filled with circulating heat exchange fluid for heat exchange with the compressed gas in the at least one or more energy storage vessel.

13. The system of claim 11, wherein the at least one wellbore heat exchanger comprises a heat exchanger coil mounted to at least one casing of the one or more energy storage vessels for exchanging heat between the compressed gas therein and an environment outside the one or more energy storage vessels.

14. The system of claim 11, wherein the at least one wellbore heat exchanger comprises a double pipe heat exchanger convective circulation system, comprising:
an inner tubing securely mounted to at least one casing and wellhead of the one or more energy storage vessels, with said inner tubing containing the compressed gas;
an annulus convective circulation system that is filled with circulating heat exchange fluid for heat exchange with the compressed gas in at least one energy storage vessel of the one or more energy storage vessels, the annulus convective circulation system comprising: an inlet for receiving a heat exchange fluid for flowing into an annulus in contact with the compressed gas in the one or more energy storage vessels; and
an outlet for transmitting thermal energy of the compressed gas, via the heat exchange fluid, out from the at least one energy storage vessel.

15. The system of claim 10, wherein the BHE comprises:
one or more boreholes drilled through the induced geothermal reservoir created by the one or more energy storage vessels; and
a heat exchange pipe inserted inside each of the one or more boreholes to allow a closed-system fluid circulation within the one or more boreholes for heat exchange between the induced geothermal reservoir and a fluid in the heat exchange pipe.

16. The system of claim 15, further comprising grout filled between the heat exchange pipe and walls of the one or more boreholes for conductive heat transfer between the induced geothermal reservoir and the one or more boreholes, and between the one or more boreholes and the heat exchange pipe.

17. The system of claim 15, wherein a fluid at a first temperature is injected into the heat exchange pipe at a first end, and is extracted via a second end of the heat exchange pipe at a second temperature, wherein the second temperature is higher than the first temperature.

18. (canceled)

19. The system of claim 15, wherein the BHE is installed and connected as a geothermal ground loop to connect multiple boreholes of the one or more boreholes for exchanging heat in the induced geothermal reservoir with a surface heat exchanger or with a thermal energy storage systems at surface.

20-23. (canceled)

24. A method of storing thermal energy in a form of compressed gas, comprising:
storing compressed gas in one or more wellbore energy storage vessels for, said energy storage vessels each comprising:
a wellbore provided in a subsurface;
a casing placed within the wellbore and cemented to a surrounding geological medium, the casing defining a volumetric space for storing the compressed gas; and
forming a geothermal reservoir in a surrounding geological medium of the one or more wellbore energy storage vessels for underground thermal energy storage (UTES), wherein a portion of thermal energy of the compressed gas stored in the one or more wellbore energy storage vessels is conductively transferred to, via the one or more storage vessels, the surrounding geological medium, and recoverably stored in the surrounding geological medium to create a geothermal system around the one or more wellbore energy storage vessels.

25. The method of claim 24, further comprising one or more of:
injecting the compressed gas into the volumetric space at a first pressure higher than a second pressure before the compressed gas is injected into the volumetric space, and retains heat generated during injection process within the volumetric space.

26-33. (canceled)
